(19) United States
(12) Patent Application Publication
(10) Pub. No.: US 2004/0125437 A1
(43) Pub. Date: Jul. 1, 2004

(54) Operating-microscope system

(76) Inventors: Martin Schmidt, Bad Schwartau (DE); Peter Schalt, Moorrege (DE)

Correspondence Address: ALIX YALE & RISTAS LLP, 750 MAIN STREET, SUITE 1400, HARTFORD, CT, 06103, US

(21) Appl. No.: 10/663,001

(22) Filed: Sep. 16, 2003

(30) Foreign Application Priority Data
Sep. 17, 2002 (EP) 02 020 833.6

(51) Int. Cl. G02B 21/00

(52) U.S. Cl. 359/368; 359/382; 359/383

(57) ABSTRACT

An operating-microscope system including an operating microscope, a carrier system for the microscope, and at least one drive element that can be actuated by a switch and is intended for moving and/or focusing a microscope includes a sterilizable hand switch arranged on the operating table. The switch is positioned and configured so that the surgeon may actuate the switch to move and/or focus the microscope without releasing the operating instrument.

### BACKGROUND OF THE INVENTION

1. Field of the Invention

The invention generally relates to operating-microscope systems having an operating microscope, a carrier system for the microscope, and at least one drive element and more specifically to actuation switches for moving and/or focusing the microscope during surgery.

2. Description of the Related Art

Operating microscopes are required for operations on fine biological structures such as the eye (opthalmology) or the brain and nervous system (neurosurgery). It is necessary for the position and focus of the operating microscope to be adjustable by the surgeon during surgery. These adjustments cannot require the surgeon to touch non-sterile surfaces.

There are already operating microscopes which, by virtue of movable carrier systems and a movable microscope suspension, allow movement about 3 translational-movement axes and 3 axes of rotation. For this purpose, these microscopes have handles, which, as is also the case with the body of the microscope itself, are covered by sterile sheeting. The surgeon grips the handle and presses a release button, as a result of which brakes in all the axes are released and the microscope can be freely positioned and rotated in space. One disadvantage of this type of system is that the surgeon usually has to put down the operating instrument to make the adjustment. Further, accurate positioning of the microscope is complicated by release of all the axes which allows the microscope to move in every direction.

In another configuration (DE 43 11 467), the operating microscope is provided with motors which allow some of the adjustments to be initiated via remote control. For example, in ophthalmology, the horizontal (XY) movement and, for focusing purposes, the vertical (Z) movement are usually initiated by a foot switch. It is also the case with neurosurgery that there are operating microscopes which allow the rotation of the microscope to be activated by foot switches or switches on the handle of the microscope. In the case of foot switches, there is no need, for corrective purposes, to put down the operating instrument, but foot switches can only be used in the sitting position. If the switch is located on the handle, the operating instrument has to be put down in order for the switch to be operated.

There are also fully robotically controlled operating microscopes in the case of which all translational and rotary movements can be controlled electrically. Here too, control usually takes place via hand switches, as a result of which the above-mentioned disadvantages cannot be avoided.

There have been trials for controlling operating microscopes via voice signals, head movements or eye movements. These techniques, however, have not gained widespread acceptance since they require too much concentration on the part of the surgeon and there is a risk of signals given being misinterpreted.

### SUMMARY OF THE INVENTION

An object of the invention is to provide a new and improved operating microscope where the switch for moving and/or focusing the microscope can be operated by the surgeon without requiring the surgeon to release the operating instrument.

The object is achieved according to the invention in that the switch is designed as a sterilizable hand switch that can be arranged on the operating table. Since the switch can be arranged on the operating table, it is provided in very close proximity to the patient and/or the operating area, with the result that the operator can actuate the switch without putting down the operating instrument. It is also the case here that his/her hand does not become contaminated since the switch can be sterilized. This thus gives the advantage of particularly precise manual control without the disadvantages of the prior-art control means.

Surprisingly, it has been found that such switches, on the one hand, can react to very low forces, with the result that they can be actuated, for example, by the little finger, but, on the other hand, are robust enough to be sterilized. This hand switch thus allows the movements and/or focusing of the microscope to be controlled in a straightforward manner. All that is required is for this microscope to be roughly adjusted prior to the operation, which can take place manually or else mechanically via switches which need not be sterilizable. The actual precision adjustment, however, is then carried out, and regulated, via the hand switch during the operation.

The switch may be provided with a heavy base, with the result that it cannot be easily displaced on the operating table. It is particularly expedient, however, that the switch have devices for fastening to the operating table, since there is then less risk of the switch being accidentally displaced.

In arrangements where the switch is connected to the operating microscope drive unit by a cable, the cable and connector are preferably also sterilizable. The problems with respect to sterilizing the cable and/or the connector may be avoided if the switch is provided with a wireless connection to the drive element or the supply unit thereof. Possible wireless connections here are, in particular, an infrared connection, ultrasonic connection or radio connection.

The devices for fastening on the operating table can also expediently be sterilized and have a clamp and an adjustable connecting element between the clamp and switch. The connecting element may have a bead chain, a swan-neck or an arrangement of tubes or rods connected by joints or clips.

It is particularly expedient if the switch has a base and a hook-like or undercut actuating element extending from the base. Such an actuating element may be pressed down or, by way of rear-engagement, raised. It would thus be possible to control the focusing in both directions. It is particularly expedient for this purpose if the actuating element is mushroom-shaped. This mushroom shape is also particularly expedient if the actuating element can be moved in two perpendicular essentially horizontal directions and in an essentially vertical direction and has six corresponding switching functions. The mushroom-shaped actuating element can thus be moved horizontally forward or back in two perpendicular directions, and can thus control the position or pivoting of the operating microscope in two perpendicular horizontal planes X, Y. Focusing takes place by virtue of the actuating element being raised or pressed down. Of course, it would also be possible, however, for the actuating element to be of some other shape, e.g. T-shaped. The only difference in this case would be that the actuating forces which are to be exerted in the X direction or Y direction are no longer equal.

It is expedient here for the actuating directions in the X and Y directions to be parallel to the pivoting directions of the microscope. Should this not be attainable during installation of the switch, it is expedient if the switch can be adjusted about a vertical axis, in order to achieve this parallel arrangement.

### BRIEF DESCRIPTION OF THE DRAWINGS

The invention is described hereinbelow by way of an exemplary embodiment and with reference to the attached drawings, in which:

FIG. 1 is a perspective view of an exemplary operating microscope system employing an actuating switch according to aspects of the present invention;

FIG. 2 is a perspective view of a first embodiment of a hand switch according to aspects of the present invention; and

FIG. 3 is a perspective view of a second embodiment of a hand switch according to aspects of the present invention.

### DETAILED DESCRIPTION OF THE EXEMPLARY EMBODIMENTS

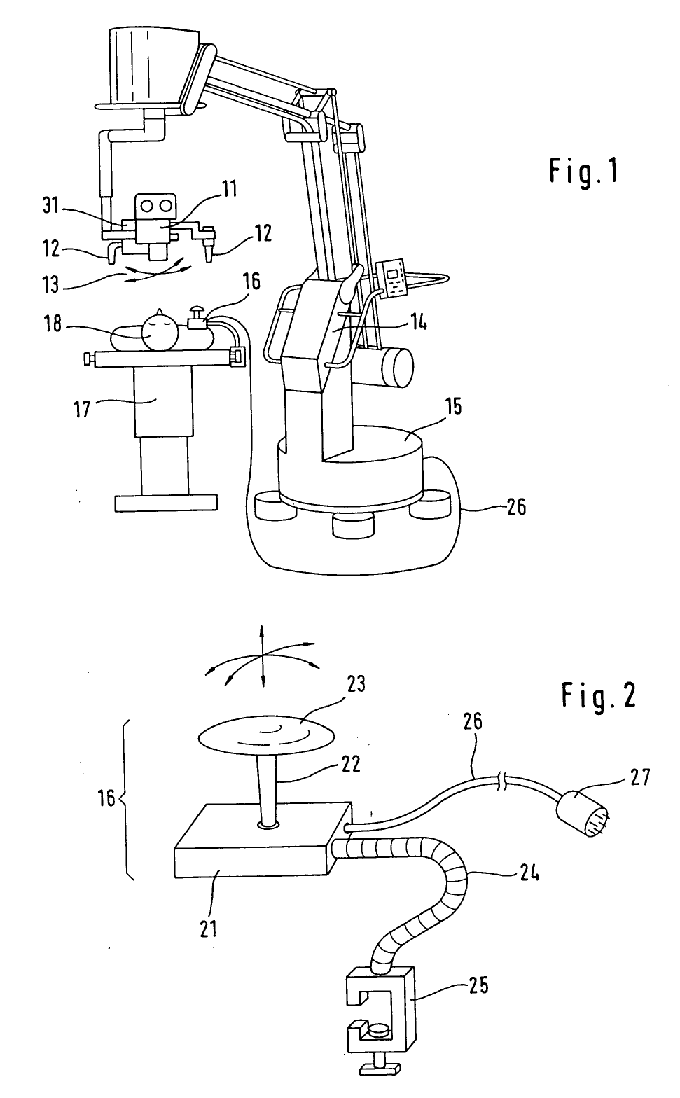

In FIG. 1, the operating microscope system includes an operating microscope 11, which is usually equipped with handles 12. The operating microscope 11 here is equipped with motors 31 for the rotary movements 13 and focusing purposes. For suspending the operating microscope 11 in space, use is made of the carrier system 14, which contains an electric supply unit 15 with an electrical connection for the motors. A hand switch 16 is fastened on the operating table 17, on which the patient 18 lies in accordance with aspects of the present invention. Fastening the hand switch 16 on the operating table 17 places the hand switch 16 in the vicinity of the operating area where it can be operated by the surgeon during the operation without him/her having to put down the operating instrument. The hand switch 16 may be connected to the supply unit 15 for the motors via a connecting cable 26 or a wireless connection 32.

FIG. 2 illustrates one embodiment of the hand switch 16. A lever 22, which includes a hemispherical cap 23, a plate or a hook at the top end, is fitted on a base 21. In this case, the lever 22 and/or the hemispherical cap 23, the plate or the hook are formed such that the surgeon can use his/her little finger both to move the lever laterally and to press or raise it vertically. The lateral movement preferably controls the rotary movement 13, which, when one looks through the microscope, appears as the XY movement. The focus is actuated by virtue of the lever 22 being pressed and raised.

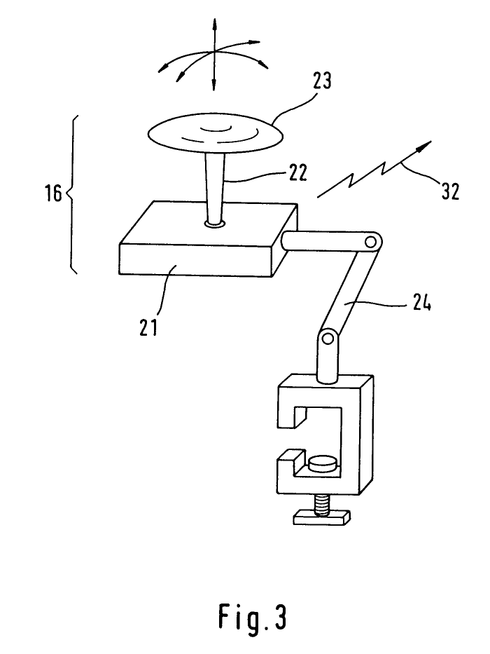

The hand switch 16 is connected to a clamp 25 via an arm 24. The arm 24 contains a plurality of joints that allow the hand switch 16 to be positioned optimally in relation to the operating area. The joints can here be secured in position. It is possible, for example, for the arm 24 to comprise a bead chain, which is kept in a certain shape via an inner tensionable wire cable. It is also possible for the arm 24 to comprise a “swan-neck”, which is stiff enough to maintain its shape during the operation. It is also possible, however, for the arm 24 to be configured from a plurality of rods or tubes which are connected to one another by joints or clips, as is indicated in FIG. 3. The clamp 25 is configured such that it can be fitted on the customary clamping rails on operating tables or on the other parts fitted on the operating table, e.g. the head support.

Extending from the hand switch 16 is a cable 26, which can be connected to the supply unit of the stand via a connector 27. It is thus possible for switching signals to bring about the rotation 13 of the microscope 11 and also the focusing thereof. It is also possible to fit an intermediate cable between the connector 27 and the supply unit 15. In another embodiment, the cable 26 may also be dispensed with altogether if the hand-switch 16 contains a unit for transmitting electromagnetic waves, light pulses or ultrasonic signals and a receiver for these signals is fitted on the supply unit 15. This case is indicated at 32 in FIG. 3.

It is important for the hand switch 16 and the arm 24 to be of sterilizable configuration. Otherwise, the hand switch 16 would have to be covered by sterile sheeting during the operation, as a result of which the direct sense of feel would be lost. The hand switch 16 preferably contains switching elements which are resistant to high temperature or consists entirely of ceramic materials and metals. If, moreover, the arm 24, the clamp 25, the cable 26 and the connector 27 are likewise designed for high temperatures, e.g. by way of silicone and Teflon insulation of the electrical parts, it is possible to carry out sterilization by way of hot air (165° C.) or autoclaving (134° C.). Otherwise, the hand switch 16 has to be sterilized chemically (liquid immersion, gas sterilization) or by plasma sterilization.

While exemplary embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed is:

1. An operating-microscope system for operations on fine biological structures of a patient on an operating table, the operating microscope system comprising:
an operating microscope;
a carrier system for the microscope;
at least one drive element for moving and/or focusing the microscope; and
a sterilizable hand switch operatively connected to actuate said drive element,
wherein said sterilizable hand switch is arrangeable on the operating table.

2. The operating-microscope system of claim 1, wherein the switch includes devices for fastening the switch to the operating table or to parts which extending from the operating table.

3. The operating-microscope system of claim 1, wherein the switch is connected to the drive element or the supply unit thereof, by a cable.

4. The operating-microscope system of claim 2, wherein the switch is connected to the drive element or the supply unit thereof, by a cable.

5. The operating-microscope system of claim 1, wherein the switch is connected in a wireless manner to the drive element or the supply unit thereof.

6. The operating-microscope system of claim 2, wherein the switch is connected in a wireless manner to the drive element or the supply unit thereof.

7. The operating-microscope system of claim 2, wherein said devices for fastening are sterilizeable and comprise a clamp and an adjustable connecting element between the clamp and the switch.

8. The operating-microscope system of claim 3, wherein said devices for fastening are sterilizeable and comprise a clamp and an adjustable connecting element between the clamp and the switch.

9. The operating-microscope system of claim 4, wherein said devices for fastening are sterilizeable and comprise a clamp and an adjustable connecting element between the clamp and the switch.

10. The operating-microscope system of claim 7, wherein the connecting element comprises a bead chain, a swan-neck or an arrangement of tubes or rods connected by joints or clips.

11. The operating-microscope system of claim 1, wherein the switch has a base and a hook-like or undercut actuating element extending from the base.

12. The operating-microscope system of claim 11, wherein the actuating element is mushroom-shaped.

13. The operating-microscope system of claim 11, wherein the actuating element is moveable in two perpendicular essentially horizontal directions and in an essentially vertical direction and has six corresponding switching functions.

14. The operating-microscope system of claim 1, wherein the switch is adjustable about a vertical axis.

15. The operating-microscope system of claim 13, wherein the switch is adjustable about a vertical axis.

16. The operating-microscope system of claim 2, wherein the switch has a base and a hook-like or undercut actuating element extending from the base.

17. An operating microscope system comprising:
an operating microscope including an actuator for focusing the microscope;
a carrier system for the microscope, said carrier system comprising at least one motor for moving said microscope;
a sterilizable hand switch for activating said actuator or said at least one motor; and
an operating table for supporting a patient,
wherein said sterilizable hand switch is arranged on said table.

18. The operating microscope system of claim 17, comprising:
a clamp for fastening said sterilizable hand switch to said table; and
an adjustable connecting element between said clamp and said switch.

19. The operating microscope system of claim 17, wherein said sterilizable hand switch is connected to said actuator and said motor by a connection selected from a cable or a wireless connection.

20 The operating microscope system of claim 18, wherein said adjustable connecting element is selected from a bead chain, a swan-neck or an arrangement of tubes or rods connected by joints or clips.
